(19) United States
(12) Patent Application Publication
(10) Pub. No.: US 2007/0081428 A1
(43) Pub. Date: Apr. 12, 2007

(54) Transcribing dictation containing private information

(75) Inventors: Rajeev Malhotra, Weston, MA (US); Rajen J. Shah, Northwood (GB); Manisha B. Sharma, Bedford, MA (US)

Correspondence Address: EDWARDS & ANGELL, LLP, P.O. BOX 55874, BOSTON, MA, 02205, US

(73) Assignee: Spryance, Inc.

(21) Appl. No.: 11/238,253

(22) Filed: Sep. 29, 2005

(51) Int. Cl. G11B 19/00; G11B 21/08; G11B 21/12

(52) U.S. Cl. 369/25.01

(57) ABSTRACT

Private information is removed from dictation so that the transcriptionist never has access to the private information. A software program is used to first extract the private information and then later (after the transcription is completed by, for example, the transcriptionist) reinsert the removed private information back into the final report. This eliminates any possibility of a human in the transcription process accessing the private information.

### TECHNICAL FIELD

The invention generally relates, but is not limited, to transcribing medical dictation that may contain private information and, more particularly, to transcribing the medical dictation at a remote location while maintaining the private information confidential.

### BACKGROUND INFORMATION

Medical transcription is the conversion of dictation into a typed and formatted report. Typically, a doctor dictates medical notes into some form of audio device to be stored as an audio file. The audio file, together with patient identification information, such as patient Medical Reference Number, patient Account Number, Patient Name, and the like, are sent to a transcription company where a textual report including the appropriate patient information is generated from the audio file and patient identification information.

The patient identification information, known as protected health information (PHI), is confidential and has to be protected at all times to ensure the privacy of the patient. Presently, in the United States, the standards for privacy and security of health information are defined in a regulation called The Health Insurance Portability and Accountability Act of 1996 (HIPAA). PHI under HIPAA includes any individually identifiable health information. More broadly, PHI also includes health information with data items that reasonably could be expected to allow individual identification.

PHI can be stripped from files to allow for access and distribution of the files. Such stripped files are known as de-identified health information. De-identified health information neither identifies nor provides a reasonable basis to identify an individual. The following identifiers of the individual or of relatives, employers, or household members of the individual must be removed to achieve the ‘safe harbor’ method of de-identification: Names; All geographic subdivisions smaller than a state, including street address, city, county, precinct, zip code, and their equivalent geo-codes; All elements of dates (except year) for dates directly related to the individual, including birth date, admission date, discharge date, date of death; Telephone numbers; Fax numbers; Electronic mail addresses; Social security numbers; Medical record numbers; Health plan beneficiary numbers; Account numbers; Certificate/license numbers; Vehicle identifiers and serial numbers, including license plate numbers; Device identifiers and serial numbers; Web Universal Resource Locators (URLs); Internet Protocol (IP) address numbers; Biometric identifiers, including finger and voice prints; and Full face photographic images and any comparable images. Many of the above listed data typically are present in a physician's dictation and resulting transcribed reports, which exposes patients' identity and makes health records vulnerable, if placed in the wrong hands.

The transcription of physician audio files is a significant task and, therefore a medical transcription industry has evolved to address this need. The medical transcription industry is primarily an outsourced industry whereby the transcription work is performed by people not directly employed by the hospitals and doctors who request and require the transcription services. The medical transcriptionists may be working within the offices of transcription companies, or at home via a distributed computer network. With the arrival of the information age, the location of the transcription is not restricted. As a result, it is common for the transcriptionist to work and reside in another country.

In a typical system, the dictator, typically a doctor, dictates a medical report into one of several possible devices—a dedicated dictation device such as those sold by vendors such as Dictaphone; a hand-held dictation machine with a magnetic tape or electronic storage system; or a dictation service via a toll-free or toll telephone number. The dictation can be done in a hospital, a doctor's office, or anywhere with available phone service. The dictation file, which is in some standard audio format, is sent to the transcription company to be typed up into a report. The transmission is typically done through a high speed network and ends up on a computer that belongs to the transcription company. Patient information such as job demographics and admissions discharge transfer information (ADT) is supplied by the dictator and/or the hospital information system.

At the transcription company, the audio files are assigned to specific medical transcriptionists (MTs) who type the report, and incorporate any patient-specific data from the demographics. The transcription company converts the text into a formatted layout and quality assurance checks for errors, i.e., that the content and the formatting are per the requirements of the customer. Once the report is completed, the report is delivered back to the hospital and/or doctor. The delivery is typically done electronically, via a network, and ends up either as a printout or in the hospital electronic medical record (EMR) system. It is note worthy that the MT, who performs the transcribing process, has access to the PHI. The PHI is also available to individuals who perform the formatting and quality assurance processes.

One example of a system attempting to comply with privacy regulations related to data is described in U.S. Pat. No. 6,804,787 to Verisma Systems, Inc.

### SUMMARY OF THE INVENTION

The invention relates, but is not necessarily limited, to quickly and easily transcribing dictation without exposing confidential data that is located within the dictation and/or in attachments to the dictation. A computer can be used to efficiently locate and remove PHI and then also to insert the removed PHI back after the bulk of the transcription is completed by, for example, a traditional method. That is, prior to generating a final transcription, the computer reincorporates the removed PHI so that the transcriptionist never is allowed access to the PHI.

In one aspect, the subject technology eliminates access to the PHI by removing all PHI from the audio file before the transcription process is started, and filling the information into the final report after all transcription (transcribing, formatting, quality assurance) steps have been completed.

In one embodiment, the invention is embodied in a method for removing any PHI from the dictation so that the medical transcriptionist never has access to the PHI. Software extracts and refills the PHI back into the final report, thereby eliminating any possibility of a human in the medical transcription company accessing the PHI. After the transcription process, another process (reincorporation) processes the typed-up report. Reincorporation can run on the same server that was responsible for removing the PHI earlier. During reincorporation and afterwards, the report is not accessible by the MT and so the PHI is safe. The server searches the report for the bookmarks, and inserts the text that had been removed from the audio earlier. The report is then ready to send to the hospital and/or doctor.

There is provided, in accordance with an embodiment of the present invention, a server for facilitating a transcription system, wherein the server communicates with clients via a distributed computing network, and wherein the server includes (a) a memory storing an instruction set and audio data related to subjects and (b) a processor for running the instruction set, the processor being in communication with the memory and the distributed computing network, wherein the processor is operative to: (i) receive an audio file; (ii) filter the audio file based upon hints to locate at least one location of private data; (iii) replace the private data with a placeholder to generate a revised audio file; (iv) provide the revised audio file to a transcriptionist; (v) receive a text file based upon the revised audio file from the transcriptionist; and (vi) replace the placeholder with the original private data.

The audio file relates to a person and the original private data is selected from the group consisting of names, geographic subdivisions smaller than a state, street address, city, county, precinct, zip code, geo-codes, birth date, admission date, discharge date, date of death, telephone numbers, fax numbers, electronic mail addresses, social security number, medical record numbers, health plan beneficiary numbers, account numbers, certificate / license numbers, vehicle identifiers, vehicle license plate numbers, Universal Resource Locators, Internet Protocol address numbers, biometric identifiers, finger prints, voice prints, face photographic images and combinations thereof. Further, the distributed computing network is the Internet.

In another embodiment, a server facilitates transcription of an audio file. The server includes a) a microprocessor; and b) memory operatively connected to the microprocessor, the memory having: i) a first database for storing a plurality of audio files and supporting data files associated with the plurality of audio files; ii) a second database for storing data related to protected health information (PHI); iii) a recogniser module for selecting an audio file with an associated supporting data file and filtering the audio file based upon the data related to PHI and the associated supporting data file such that PHI in the audio file is blanked.

In another embodiment, a method for transcribing an audio file includes the steps of stripping an audio file of private information to create a blanked file and providing the blanked file to a transcriptionist.

Additionally, the method may include the steps of associating secondary files with the audio file and restricting access to the secondary files. The secondary files include demographic data related to a subject of the audio file. Additionally, the method may also include the steps of creating a table containing data related to location and keyword type of the private information creating a text report based upon the stripped audio file, wherein the text report has bookmarks associated with the location of the private information and providing the table and the text report to the transcriptionist.

Still another embodiment of the subject invention is directed to a method for safeguarding protected health information (PHI) during transcription of an audio file created by a doctor relating to a patient, wherein the method includes the steps of creating a file based on the audio file, wherein the file has the PHI of the audio file and data related to the PHI of the patient and restricting access to the file. Additionally, the method may further include the steps of stripping the audio file of the PHI to create a blanked file and providing the blanked file to a transcriptionist, wherein the transciptionist is restricted from accessing the file. The data related to the PHI is locations for the PHI within the audio file.

In another embodiment, the invention is embodied in a computer-readable medium. The computer readable medium causes a computer to perform a method for transcribing dictation having protected health information (PHI), the computer having a digital signal processor and a program with functions for invocation by performing the steps of a) receiving an audio file with associated patient data, b) receiving a driver file including keywords, hints and phrases, c) converting the audio file into a text file, d) identifying and blanking the PHI within a revised audio file and a revised text file by using the driver file and the associated patient data, e) capturing location, length, identity and bookmark data for the PHI in a table, f) sending the revised audio file and the revised text file to a transcriptionist, g) receiving a transcription with placeholders based on the revised audio file and the revised text file from the transciptionist and h) replacing the placeholders of the transcription with the PHI based on the table.

It should be appreciated that the present invention can be implemented and utilized in numerous ways including, without limitation, as a process, an apparatus, a system, and a device. The invention can be implemented entirely or partially in software and/or hardware. The software can be contained on or in any computer readable medium. Certain embodiments of the invention and related aspects, features, and benefits will become more readily apparent from the following description and the accompanying drawings.

### BRIEF DESCRIPTION OF THE DRAWINGS

The drawings generally are to illustrate principles of the invention and/or to show certain embodiments according to the invention. The drawings are not necessarily to scale. Each drawing is briefly described below.

FIG. 1 is a diagram showing an environment having a transcription system in accordance with the subject disclosure.

FIG. 2 is a block diagram of a server operated by a transcription company in accordance with the subject disclosure.

FIG. 3 is a somewhat schematic flow diagram illustrating movement of data through the system of FIG. 1.

FIG. 4 is a text version of an audio file with the PHI blanked in accordance with the subject disclosure.

FIG. 5 is a text version of the audio file of FIG. 3 after reincorporation of the PHI.

### DESCRIPTION

In brief overview, the invention generally relates, but is not necessarily limited, to removing PHI before all or the bulk of the transcription work is done and then thereafter putting back the removed PHI. A software program can be used to automate and accomplish the removal and the reinsertion of the PHI. The program can eliminate any human contact with the PHI during the transcription process.

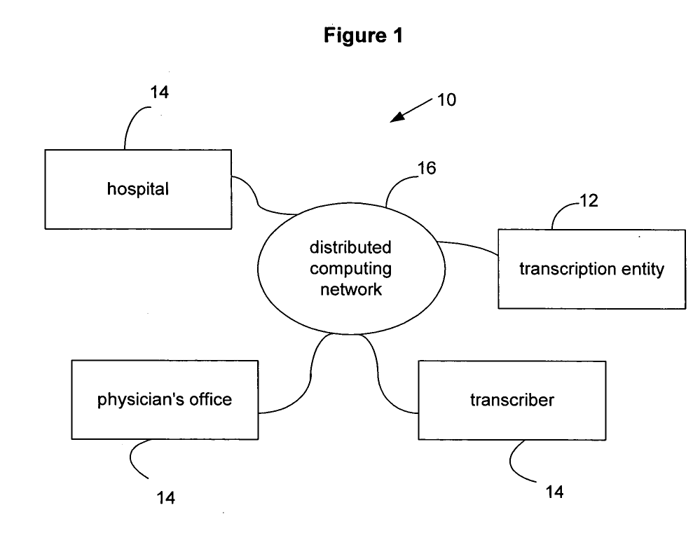

Referring now to the FIG. 1, an environment 10 allows on-line users (doctors, hospitals, caregivers, respective support staff and the like, for example) to connect with a transcription system. The transcription system can be user-interactive and self-contained so that users need not go to another location or address within a distributed computing network to access various information and functions. The following discussion describes the structure of the environment 10, but discussion of a software application that embodies one aspect of the invention is described elsewhere herein.

The environment 10 includes a server 12 associated with a transcription company and a plurality of clients 14 associated with hospitals, doctors and transcribers as indicated. For simplicity, only one server 12 and three clients 14 are shown. The server 12 and clients 14 communicate over a distributed computer network 16 via communication channels, whether wired or wireless, as is known to those of ordinary skill in the pertinent art. In one embodiment, the distributed computer network 16 is the Internet. Server 12 hosts multiple Web sites and houses multiple databases necessary for the proper operation of the transcription system in accordance with the subject invention.

The server 12 can be one or more servers known to those skilled in the art that are intended to be operably connected to a network so as to operably link to a plurality of clients 14 via the distributed computer network 16. As illustration, the server 12 typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server 12 may be used for storing data, client applications and the like utilized by client applications. The hard disk drive(s) of the server 12 also are typically provided for purposes of booting and storing the operating system, other applications or systems that are to be executed on the server 12, paging and swapping between the hard disk and the RAM.

It is envisioned that the server 12 can utilize multiple servers in cooperation to facilitate greater performance and stability of the subject invention by distributing memory and processing as is well known. For reference, see, for example, U.S. Pat. No. 5,953,012 to Venghte et al. and U.S. Pat. No. 5,708,780 to Levergood et al.

Distributed computer network 16 may include any number of network systems well known to those skilled in the art. For example, distributed computer network 16 may be a combination of local area networks (LAN), wide area networks (WAN), or, as is well known. For the Internet, one method of accessing information is the World Wide Web via browser software, which allows navigation in an intuitive way and requires little if any training to use. It is also envisioned that the distributed computer network is a non-web system, such as a single computer. For example, mainframe and/or a multi-user system is also suitable. Further, systems that use remote desktops on a Windows server, such as Citrix, are also suitable. Connectivity may be achieved through a virtual private network (VPN) across the Internet, a dedicated dial-up, a purpose specific hard-wired network and the like as would be appreciated by those of ordinary skill in the pertinent art.

The plurality of computers or clients 14 can be desktop computers, laptop computers, personal digital assistants, cellular telephones and the like now known and later developed. The clients 14 can be special purpose computers that allow users to create, store, and access audio files for transmission to the server 12. The clients 14 can have displays as will be appreciated by those of ordinary skill in the pertinent art. The display may be any of a number of devices known to those skilled in the art for displaying images responsive to outputs signals from the computers 14. Such devices include, but are not limited to, cathode ray tubes (CRT), liquid crystal displays (LCDS), plasma screens and the like. Although a simplified diagram is illustrated in FIG. 1 such illustration shall not be construed as limiting the present invention to the illustrated embodiment. It should be recognized that the signals being output from the computer can originate from any of a number of devices including PCI or AGP video boards or cards mounted within the housing of the clients 14 that are operably coupled to the microprocessors and the displays thereof.

Clients 14 typically allow doctors or their support staff to create audio files whereas the server 12 hosts a Web site to allow the users to submit the audio files for transcription. It will be recognized by those of ordinary skill in the art that the hardware of the clients 14 would often be interchangeable with that of the server 12. At a hospital, for example, a plurality of users typically share the same client 14 and cookie technology can be utilized to facilitate access to the environment 10 and, thereby, the transcription system. A plurality of users can utilize the environment 10 simultaneously.

The clients 14 also can be equipped with input devices, which are known to those skilled in the art. The input devices can be used to provide input signals for control of applications programs and other programs such as the operating system being executed on the clients 14. In illustrative embodiments, input devices are a microphone to record speech, a keyboard, and a mouse. In another embodiment, the client 14 includes a data port for receiving an audio file from a portable recording device. A switch, a slide, a track ball, a glide point or a joystick, a microphone or other such device (e.g., a keyboard having an integrally mounted glide point or mouse) by which a user such as a doctor can input control signals and other commands is also envisioned.

The clients 14 typically include a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/ or writing to removable computer readable media and an operating system for execution on the central processing unit. According to one embodiment, the hard disk drive of the clients 14, 16 is for purposes of booting and storing the operating system, other applications or systems that are to be executed on the computer, paging and swapping between the hard disk and the RAM and the like. In one embodiment, the application programs reside on the hard disk drive for performing the functions in accordance with the transcription system. In another embodiment, the hard disk drive simply has a browser for accessing an application hosted within the distributed computing network 16. The clients 14 can also utilize a removable computer readable medium such as a CD or DVD type of media that is inserted therein for reading and/or writing to the removable computer readable media.

The flow chart herein illustrates the structure or the logic of an embodiment of a computer program according to the invention. The program is for execution in the environment 10. The flow chart illustrates the structures and functions of the computer program code elements (which could instead be implemented entirely or partially as one or more electronic circuits). As such, the present disclosure may be practiced in its essential embodiments by a machine component that renders the program code elements in a form that instructs a digital processing apparatus (e.g., computer) to perform a sequence of function steps corresponding to those shown in the flow diagrams. The software and various processes discussed herein are merely exemplary of the functionality performed by the disclosed technology and thus such processes and/or their equivalents may be implemented in commercial embodiments in various combinations and quantities without materially affecting the operation of the disclosed technology.

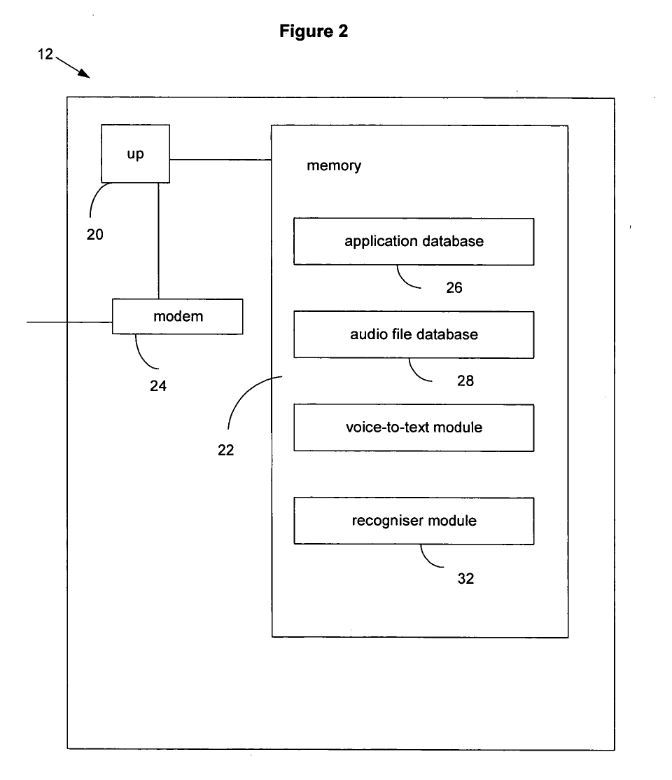

Referring now to FIG. 2, a block diagram of the server 12 is illustrated. A microprocessor 20 controls the operation of the server 12. The instruction sets and other necessary data for operation of the server 12 are stored in memory 22, which is operatively connected to the microprocessor 20. The server 12 also includes a modem 24 for communicating with the distributed computing network 16.

A transcription company operates the server 12 to host a Web site to provide access for health care practitioners and related users to utilize the transcription system. It is envisioned that the transcription system provides for administration and security maintenance. Therefore, although each user (e.g., doctors and transcribers) of the subject invention has access to a user interface, each group's access is controlled. The interface specifies which aspects of the program can be accessed, and at what level in order to maintain compliance with technical electronic data interchange standards and legal confidentiality restraints such as HIPAA. Such limitations of functionality are well known to those skilled in the art and therefore not further described herein. When a health care provider contracts for access to the transcription system, she or a member of the staff is typically provided with password access.

The transcription system can operate as an application on the server 12 in the environment 10 of FIG. 1. An application database 26 within the memory 22 stores the transcription system instruction set. The memory 22 also includes an audio file database 28, a voice-to-text module 30 and a recogniser module 32 as are described in more detail hereinbelow.

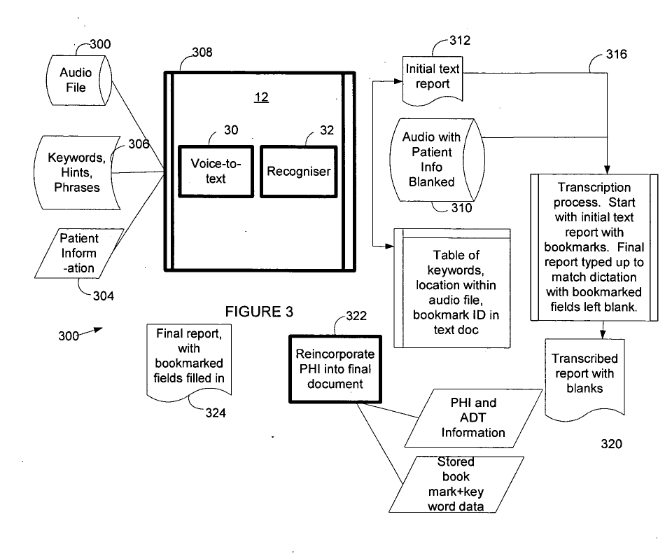

Referring now to FIG. 3, there is illustrated a flowchart 300 depicting a process for facilitating transcription of audio files in accordance with an embodiment of the present invention. At step 302, a doctor creates an audio file with a digital voice recorder (not shown) or related device for storage on the doctor client 14. The digital voice recorder can store the audio file in flash memory and easily interface with the doctor client 14 to transfer the audio file thereto. In another embodiment, the digital voice recorder is fully functional to act as the doctor client 14.

At step 304, either the doctor or a member of the support staff creates and stores supporting data or patient information for association with the audio file. The supporting data can be demographic data such as social security number of the patient related to the audio file. The supporting data further includes any information that is necessary to be included in the patient's file such as reports, lab result, insurance information, prescription data and the like. In another embodiment, the doctor, at the time of dictation, punches in a “patient ID” such as a Medical Record Number (MRN) or like information, which then the dictation device associates with that audio file.

At step 306, a driver file is also created that includes keywords, hints and phrases. In one embodiment, the driver file is selected from a menu of specialty specific files stored on the client 14. Although the driver file can be tailored for each particular doctor's practice area, it will be recognized that many parameters are nearly universally applied in the health care field. The audio file with associated supporting data stored on the client 14 is also sent by the doctor to the transcription company server 12 for storage.

At step 308, which runs on the transcription company's server 12, the server 12 utilizes the driver file, a voice-to-text module 30 and a recogniser module 32 to identify the PHI within the audio file and blank out the PHI so that the MT will not hear any of the PHI in the audio file. The server 12 also captures the location and identity of such PHI so that the PHI can be refilled prior to return to the doctor client 14.

The recogniser module 32 matches patterns and understands natural language processing. Hints drive the recogniser module 32. Hints are key words and phrases that would contain PHI, and actual words and numbers from within the associated supporting data. Examples of hints are “patient's name”, “Medical Record Number”, “MRN”, “Social Security Number”, “SSN”, “date of birth” and, “DOB”. In one embodiment, the hints are standardized so that doctors can become familiar with using the hints so that the recogniser module 32 need only search for the standard hints. The hints are used by the recogniser module 32 to find PHI and blank the PHI. The transcription system notes the location of the piece that was blanked out. In one embodiment, the hints are used to replace the actual PHI. If necessary, in the case of the audio file being analog, an A/D converter module (not shown) converts the audio file into digital data for use by the recogniser module 32. It is envisioned that the coversion of the audio file from analog to digital and back may occur at any time in the process.

At step 310, the recogniser module 32 generates a revised audio file with the PHI removed. To create the revised audio file, the original audio file is copied and the PHI is removed and blanked. Blanking is either erasing the dictated words and leaving a blank sound, or is the insertion of a descriptor, key word or hint that was detected. Based upon the insertion, the MT knows what information was removed and can ensure that the final report has the correct bookmark for the final reincorporation process.

In one embodiment, the server 12 generates a set of data that identifies the following information for each PHI identified: a location in the audio file; a length of the sound(s); an identifier such as a patient name, an MRN, a social security number; and a bookmark name that is used to note its position in the output text document. As a result, a revised audio file and correlating set of data (e.g., a text file with bookmarks and text containing the PHI that has been blanked) are relationally stored in the audio file database 28.

At step 312, the locations of the PHI are stored in a text file. The text file is eventually sent to the MT to aid in the transcription process. In another embodiment, using the PHI data and the revised audio file, the voice-to-text module 30 generates a transcription of the revised audio file. At step 314, the server creates a table including the keywords and the locations of the keywords in the audio file.

At step 316, the revised audio file and initial text report are sent to the MT. In another embodiment, a text version of the audio file generated by the voice-to-text module 30 is also sent to the MT to assist with the final sanitized text version of the audio file. It is envisioned that although shown separately, many steps, such as steps 310, 312, 314 and 316, can occur simultaneously within server 12 or in various order as would be appreciated by those of ordinary skill in the pertinent art.

At step 318, the MT uses the initial text report with bookmarks to create a transcribed report with blanks/identifiers/placeholders. The server 12 receives the transcribed report with blanks at step 320. Based upon the stored bookmark and keyword data, the server 12 reincorporates the PHI into the transcribed report to, in effect, fill in the blanks at step 322. As a result, the transcribed report is a complete text version of the audio file, yet the MT never had access to the PHI. At step 324, the bookmarked fields are filled in and the final report is returned to the doctor client 14.

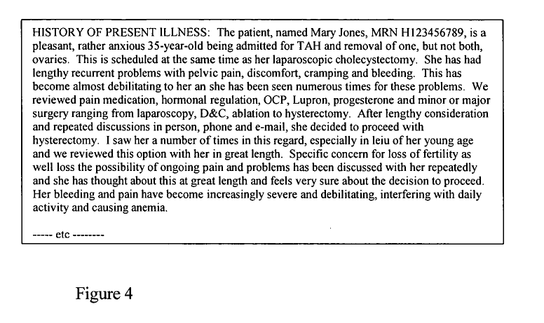

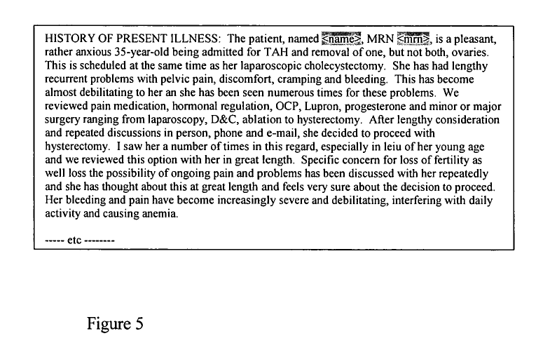

Referring to FIGS. 4 and 5, for example, a text version of an audio file and the resulting blanked version, respectively, are illustrated. As can be seen by comparison, in the first line of FIG. 4, the patients name, “Mary Jones”, has been replaced by a highlighted “<name>” in FIG. 5. In addition, the transcription system captures the following data:
[ID Name, Location 7.3, Length 2, Bookmark PatientName, value Mary Smith]
with the location and length being in seconds. The revised audio file as shown in FIG. 5 has the words “patient name” and “MRN” where the highlighted text is indicated above and so on.

In one embodiment, the transcription system is a desktop computer application that is either downloaded or provided on a compact disk. In still another embodiment, the transcription system is offered as an Internet hosted application. Each user is allowed to provide audio files directly to the transcription company.

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

What is claimed is:

1. A server for facilitating a transcription system, wherein the server communicates with clients via a distributed computing network, and wherein the server comprises:
(a) a memory storing an instruction set and audio data related to a plurality of subjects; and
(b) a processor for running the instruction set, the processor being in communication with the memory and the distributed computing network, wherein the processor is operative to:
(i) receive an audio file;
(ii) filter the audio file based upon hints to locate at least one location of private data;
(iii) replace the private data with a placeholder to generate a revised audio file;
(iv) provide the revised audio file to a transcriptionist;
(v) receive a text file based upon the revised audio file from the transcriptionist; and
(vi) replace the placeholder with the original private data.

2. A server as recited in claim 1, wherein the audio file relates to a person and the original private data is selected from the group consisting of names, geographic subdivisions smaller than a state, street address, city, county, precinct, zip code, geo-codes, birth date, admission date, discharge date, date of death, telephone numbers, fax numbers, electronic mail addresses, social security number, medical record numbers, health plan beneficiary numbers, account numbers, certificate/license numbers, vehicle identifiers, vehicle license plate numbers, Universal Resource Locators, Internet Protocol address numbers, biometric identifiers, finger prints, voice prints, face photographic images and combinations thereof.

3. A server as recited in claim 1, wherein the distributed computing network is the Internet.

4. A server for facilitating transcription of an audio file, the server comprising:
a) a microprocessor; and
b) memory operatively connected to the microprocessor, the memory having:
i) a first database for storing a plurality of audio files and supporting data files associated with the plurality of audio files;
ii) a second database for storing data related to protected health information (PHI);
iii) a recogniser module for selecting an audio file with an associated supporting data file and filtering the audio file based upon the data related to PHI and the associated supporting data file such that PHI in the audio file is blanked.

5. A method for transcribing an audio file, the method comprising the steps of:
a) stripping an audio file of private information to create a blanked file; and
b) providing the blanked file to a transcriptionist.

6. A method as recited in claim 5, further comprising the steps of:
associating secondary files with the audio file; and
restricting access to the secondary files.

7. A method as recited in claim 6, wherein the secondary files include demographic data related to a subject of the audio file.

8. A method as recited in claim 5, further comprising the steps of:
creating a table containing data related to location and keyword type of the private information;
creating a text report based upon the stripped audio file, wherein the text report has bookmarks associated with the location of the private information; and
providing the table and the text report to the transcriptionist.

9. A method for safeguarding protected health information (PHI) during transcription of an audio file created by a doctor relating to a patient, the method comprising the steps of:
a) creating a file based on the audio file, wherein the file has the PHI of the audio file and data related to the PHI of the patient; and
b) restricting access to the file.

10. A method as recited in claim 9, further comprising the steps of:
stripping the audio file of the PHI to create a blanked file; and
providing the blanked file to a transcriptionist, wherein the transciptionist is restricted from accessing the file.

11. A method as recited in claim 9, wherein the data related to the PHI is locations for the PHI within the audio file.

12. A computer-readable medium whose contents cause a computer to perform a method for transcribing dictation having protected health information (PHI), the computer having a digital signal processor and a program with functions for invocation by performing the steps of:
a) receiving an audio file with associated patient data;
b) receiving a driver file including keywords, hints and phrases;
c) converting the audio file into a text file;
d) identifying and blanking the PHI within a revised audio file and a revised text file by using the driver file and the associated patient data;
e) capturing location, length, identity and bookmark data for the PHI in a table;
f) sending the revised audio file and the revised text file to a transcriptionsist;
g) receiving a transciption with placeholders based on the revised audio file and the revised text file from the transciptionist; and
h) replacing the placeholders of the transcription with the PHI based on the table.
